(19) United States
(12) Patent Application Publication
(10) Pub. No.: US 2022/0329651 A1
(43) Pub. Date: Oct. 13, 2022

(54) APPARATUS FOR CONTAINER ORCHESTRATION IN GEOGRAPHICALLY DISTRIBUTED MULTI-CLOUD ENVIRONMENT AND METHOD USING THE SAME

(71) Applicant: Electronics and Telecommunications Research Institute, Daejeon (KR)

(72) Inventors: Soo-Young KIM, Daejeon (KR); Dong-Jae KANG, Daejeon (KR); Byoung-Seob KIM, Daejeon (KR); Seok-Ho SON, Daejeon (KR); Yun-Kon KIM, Daejeon (KR); Seung-Jo BAE, Daejeon (KR); Ji-Hoon SEO, Daejeon (KR); Byeong-Thaek OH, Daejeon (KR); Young-Woo JUNG, Daejeon (KR)

(73) Assignee: Electronics and Telecommunications Research Institute, Daejeon (KR)

(21) Appl. No.: 17/518,267

(22) Filed: Nov. 3, 2021

(30) Foreign Application Priority Data
Apr. 12, 2021 (KR) 10-2021-0047164

(51) Int. Cl. H04L 29/08; G06F 9/50

(52) U.S. Cl. CPC H04L 67/1008; G06F 9/5077; H04L 67/101; H04L 67/32; G06F 9/505

(57) ABSTRACT

Disclosed herein are a container orchestration apparatus in an environment of multiple geographically distributed clouds and a method using the same. The container orchestration method includes receiving, by the container orchestration apparatus, a service request from a device using service; and dynamically deploying, by the container orchestration apparatus, a service node and a service instance for processing the service request based on auto-scheduling of a container orchestration cluster based on the environment of multiple geographically distributed clouds.

### CROSS REFERENCE TO RELATED APPLICATION

This application claims the benefit of Korean Patent Application No. 10-2021-0047164, filed Apr. 12, 2021, which is hereby incorporated by reference in its entirety into this application.

### BACKGROUND OF THE INVENTION

### 1. Technical Field

The present invention relates generally to technology for container orchestration in an environment of multiple geographically distributed clouds, and more particularly to technology for dynamically deploying and scaling service nodes and service instances in order to minimize latency when service is provided to users using a container orchestration platform that operates in connection with multiple temporally and/or geographically distributed clouds.

### 2. Description of the Related Art

Cloud-computing technology is technology in which all computing infrastructure resources, such as CPUs, memory, storage, networks, and the like, are virtualized based on virtualization technology and in which the virtualized resources are provided as needed in response to requests from users.

With the recent advancement of virtualization technology, container technology for configuring a package in which libraries, binaries, configuration files, and the like for executing an application are bundled with the application and releasing the package separately from an Operating System (OS), rather than emulating the entire computer in the form of software or hardware, has emerged. Applications containerized through such container technology may be easily migrated to various kinds of environments (e.g., development, testing, and production environments). Also, in order to maximize such convenience, applications are being configured and developed based on microservice architecture.

Accordingly, container orchestration software platforms for easily releasing and managing a large number of containerized applications based on microservice architecture have emerged, and are widely used in various environments by being applied to cloud environments. As representative container orchestration software platforms, there are Kubernetes, Docker Swarm, Apache Mesos, and the like.

Generally, container orchestration platforms form a single cluster by grouping multiple virtual machines (referred to as ‘nodes’ hereinbelow) acquired from a cloud, and provide a lot of functions such as a function to deploy containers of applications in suitable nodes in response to user requests, an autoscaling function for automatically increasing or decreasing the number of copies of containers depending on the load on applications, and the like in order to easily manage the containers in an integrated manner.

Meanwhile, multiple/distributed/hybrid cloud technology has also emerged in order to enable flexible use of multiple clouds that are located at different locations and are provided by different cloud providers. That is, multiple/distributed/hybrid cloud technology (referred to as ‘distributed cloud technology’ hereinbelow) is technology that enables a public cloud, a private cloud, and actual physical machines to be connected with each other and used. This technology enables service to be provided by the cloud that is closest to a service user by overcoming the geographical limitations of a single cloud, thereby solving service delay problems and the like.

Here, the conventional container orchestration platforms described above are optimized for performing a function of network flow control in a cluster formed of nodes provided from a single cloud or a function of autoscaling the cluster depending on the system load (CPU usage/utilization, memory usage/utilization, and the like). However, when the conventional container orchestration technology is applied to multiple geographically distributed clouds, a service delay may occur due to a geographical problem or a network environment problem.

### Documents of Related Art

(Patent Document 1) Korean Patent Application Publication No. 10-2014-0099497, published on Aug. 12, 2014 and titled “Geolocation-based load balancing”.

### SUMMARY OF THE INVENTION

An object of the present invention is to provide container orchestration technology for multiple geographically distributed clouds such that the service response time taken to provide service in response to service requests from multiple users can be minimized.

Another object of the present invention is to perform effective scheduling and scaling for multiple geographically distributed clouds in consideration of network proximity and system load.

A further object of the present invention is to minimize a service delay time and to minimize service management costs by efficiently using all system resources when a container orchestration platform based on multiple geographically distributed clouds is operated.

In order to accomplish the above objects, a method for container orchestration according to the present invention includes receiving, by a container orchestration apparatus, a service request from a device using a service; and dynamically deploying, by the container orchestration apparatus, a service node and a service instance for processing the service request based on auto-scheduling of a container orchestration cluster based on an environment of multiple geographically distributed clouds.

Here, dynamically deploying the service node and the service instance may be configured to dynamically deploy the service node and the service instance such that a service instance execution load is balanced in consideration of network proximity of the device using the service.

Here, the network proximity may correspond to an average network latency, estimated based on a geographical distance between the device using the service and the service node.

Here, dynamically deploying the service node and the service instance may include selecting at least one candidate service node, including a service instance corresponding to the service request, from among multiple service nodes constituting the container orchestration cluster; selecting any one of the at least one candidate service node as a target service node in consideration of whether the average network latency is equal to or less than a preset reference and in consideration of balancing of the service instance execution load; and processing the service request using a target service instance deployed in the target service node.

Here, dynamically deploying the service node and the service instance may include, when a service instance that processed a previous service request made by the device using the service is present, processing the service request using the service instance that processed the previous service request.

Here, the method may further include performing, by the container orchestration apparatus, scaling of the container orchestration cluster based on resource utilization of each service node and resource utilization of each service instance.

Here, performing the scaling may include performing service instance scaling through which a service instance is added or deleted in consideration of whether the resource utilization measured for each service instance of each service type falls within a preset target range of service instance resource utilization; and performing service node scaling through which a service node is added or deleted in consideration of whether the resource utilization measured for each service node falls within a preset target range of service node resource utilization.

Here, performing the service instance scaling may be configured such that, when the resource utilization measured for at least one first service instance providing a first service falls out of the preset target range of the service instance resource utilization, the service instance is added or deleted in consideration of network proximity to at least one first service node including the at least one first service instance and in consideration of a rate of increase of access thereto by devices using the at least one first service and a frequency of access thereto during a preset period.

Here, performing the service node scaling may be configured such that, when cluster resource utilization, measured based on the resource utilization of each service node, falls out of a preset target range of cluster resource utilization, the service node is added or deleted in consideration of the resource utilization of each service node and network proximity between a cloud region and a group of devices using service, which are grouped in consideration of the rate of increase of access and the frequency of access.

Here, performing the service node scaling may include, when the cluster resource utilization is greater than an upper limit of the preset target range of the cluster resource utilization, selecting a target cloud region, in which a new service node is to be added, from among a first cloud region, including a service node having resource utilization exceeding an upper limit of the preset target range of the service node resource utilization, among multiple service nodes constituting the container orchestration cluster, and a second cloud region, selected in consideration of network proximity between the cloud region and the group of devices using service.

Here, the service node may be a virtual machine based on a cloud or a physical machine.

Also, an apparatus for container orchestration according to an embodiment of the present invention includes a processor for receiving a service request from a device using a service and dynamically deploying a service node and a service instance for processing the service request based on auto-scheduling of a container orchestration cluster based on an environment of multiple geographically distributed clouds, and memory for storing information about a state of the container orchestration cluster.

Here, the processor may dynamically deploy the service node and the service instance such that a service instance execution load is balanced in consideration of network proximity of the device using the service.

Here, the network proximity may correspond to an average network latency, estimated based on a geographical distance between the device using the service and the service node.

Here, the processor may select at least one candidate service node, including a service instance corresponding to the service request, from among multiple service nodes constituting the container orchestration cluster, select any one of the at least one candidate service node as a target service node in consideration of whether the average network latency is equal to or less than a preset reference and in consideration of balancing of the service instance execution load, and process the service request using a target service instance deployed in the target service node.

Here, when a service instance that processed a previous service request made by the device using the service is present, the processor may process the service request using the service instance that processed the previous service request.

Here, the processor may perform scaling of the container orchestration cluster based on resource utilization of each service node and resource utilization of each service instance.

Here, the processor may add or delete a service instance in consideration of whether the resource utilization measured for each service instance of each service type falls within a preset target range of service instance resource utilization, and may add or delete a service node in consideration of whether the resource utilization measured for each service node falls within a preset target range of service node resource utilization.

Here, when the resource utilization measured for at least one first service instance providing a first service falls out of the preset target range of the service instance resource utilization, the processor may add or delete the service instance in consideration of network proximity to at least one first service node including the at least one first service instance and in consideration of a rate of increase of access thereto by devices using the at least one first service and a frequency of access thereto during a preset period.

Here, when cluster resource utilization, measured based on the resource utilization of each service node, falls out of a preset target range of cluster resource utilization, the processor may add or delete the service node in consideration of the resource utilization of each service node and network proximity between a cloud region and a group of devices using service, which are grouped in consideration of the rate of increase of access and the frequency of access.

Here, when the cluster resource utilization is greater than an upper limit of the preset target range of the cluster resource utilization, the processor may select a target cloud region, in which a new service node is to be added, from among a first cloud region, including a service node having resource utilization exceeding an upper limit of the preset target range of the service node resource utilization, among multiple service nodes constituting the container orchestration cluster, and a second cloud region, selected in consideration of network proximity between the cloud region and the group of devices using service.

Here, the service node may be a virtual machine based on a cloud or a physical machine.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart illustrating a container orchestration method according to an embodiment of the present invention;

FIG. 2 is a view illustrating an example of the physical configuration of a container orchestration cluster according to the present invention;

FIG. 3 is a view illustrating an example of the logical configuration of a container orchestration cluster according to the present invention;

FIG. 4 is a flowchart illustrating in detail the process of dynamically deploying a service node and a service instance according to an embodiment of the present invention;

FIG. 5 is a flowchart illustrating a service-instance-scaling process according to an embodiment of the present invention;

FIG. 6 is a flowchart illustrating a service-node-scaling process according to an embodiment of the present invention; and

FIG. 7 is a block diagram illustrating a container orchestration apparatus according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

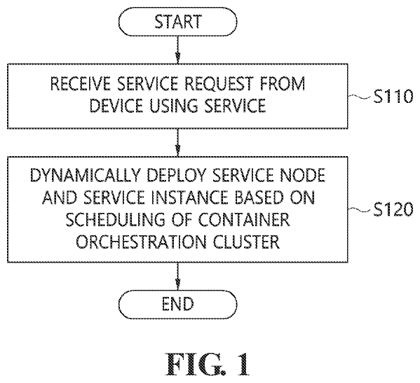

FIG. 1 is a flowchart illustrating a container orchestration method according to an embodiment of the present invention.

Referring to FIG. 1, in the container orchestration method according to an embodiment of the present invention, a container orchestration apparatus receives a service request from a device using service at step S110.

Here, the service request may be received from multiple devices that use service and are possessed by multiple users that are temporally and/or geographically distributed.

Here, the container orchestration apparatus may be a container orchestration platform constructed for virtual machines of multiple geographically distributed clouds and local physical machines.

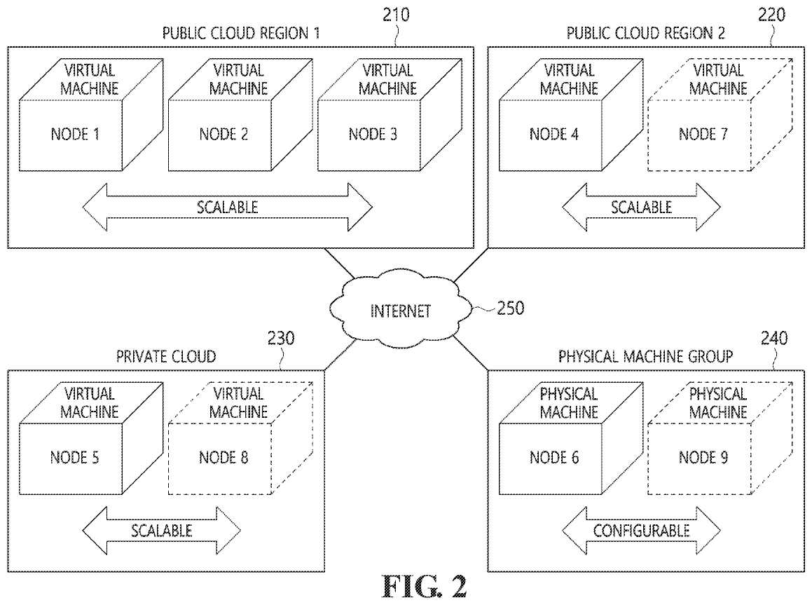

For example, a container orchestration cluster in the form illustrated in FIG. 2 may be configured by constructing a container orchestration platform according to an embodiment of the present invention.

Referring to FIG. 2, the container orchestration cluster according to an embodiment of the present invention may include a first public cloud region (public cloud region 1) 210, a second public cloud region (public cloud region 2) 220, a private cloud 230, and a physical machine group 240.

Here, the region provided by a public cloud may be a group of multiple data centers that are installed in order to stably provide a cloud service. Generally, a public cloud region may be configured by grouping two or three data centers.

Here, virtual machines provided from respective clouds may be located in different regions, and may operate with a time difference. That is, the virtual machines may be geographically and temporally distributed.

Here, physical machines included in the physical machine group 240 do not use a cloud service, and may be provided by a cluster administrator.

Here, the virtual machines and the physical machines included in the respective groups may communicate with each other by being connected over the Internet 250.

Here, the respective virtual machines and physical machines may be managed as service nodes in the container orchestration cluster. That is, a service node according to an embodiment of the present invention may be a virtual machine based on a cloud or a physical machine.

For example, as illustrated in FIG. 2, the virtual machines created in the first public cloud region (public cloud region 1) 210 may be respectively managed as node 1, node 2, and node 3, the virtual machines created in the second public cloud region (public cloud region 2) 220 may be respectively managed as node 4 and node 7, the virtual machines created in the private cloud 230 may be respectively managed as node 5 and node 8, and the physical machines in the physical machine group 240 may be respectively managed as node 6 and node 9.

Here, node 7 and node 8 marked with the dotted line in FIG. 2 denote virtual machines capable of being added to the second public cloud region (public cloud region 2) 220 and the private cloud 230 through scaling by a cluster constructor or provider, and node 9 denotes a configurable physical machine capable of being directly added to or deleted from the physical machine group 240.

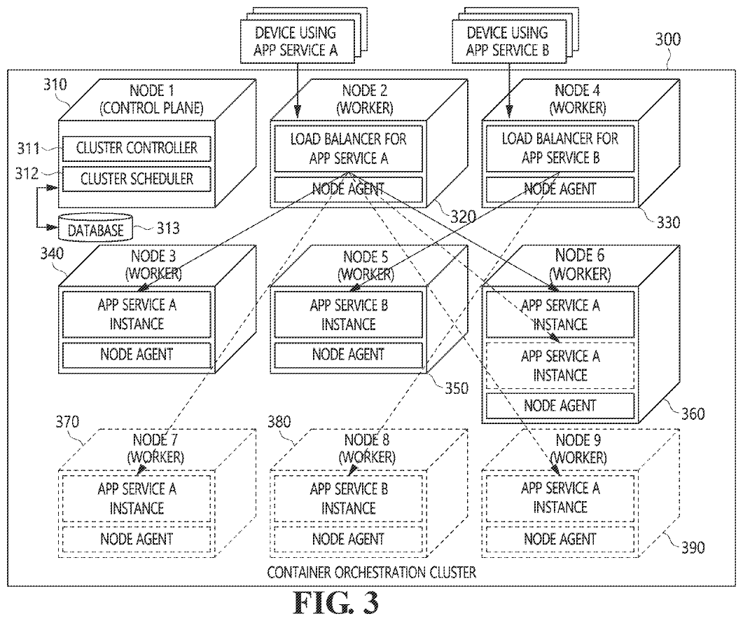

The logical configuration of this container orchestration cluster may have the form illustrated in FIG. 3.

Referring to FIG. 3, nodes constituting the container orchestration cluster are separately managed by being classified into control planes and workers depending on the roles thereof.

A service node 310 corresponding to a control plane includes a cluster controller 311 and a cluster scheduler 312, and may store and manage state information pertaining to the container orchestration cluster using a separate database 313.

Each of service nodes 320 to 390 corresponding to workers may include a node agent and service instances.

Here, app service A instances marked with the dotted line in service node 6 360, service node 7 370, and service node 9 390 indicate that they are capable of being added or deleted through scaling at the level of the corresponding service nodes. Similarly, an app service B instance marked with the dotted line in service node 8 380 indicates that it is capable of being added or deleted through scaling at the level of the corresponding service node.

The cluster controller 311 may perform the task of receiving a request from a cluster administrator or an application service administrator and the task of continuously checking the current state of the cluster and changing the same so as to match the cluster state desired by the cluster administrator or the application service administrator. That is, the cluster controller 311 may monitor cluster state information stored in the database 313, and may continuously check the current state of the cluster while receiving an event triggered by a change in the states of various kinds of service instances from the node agents of the service nodes. Also, the cluster controller 311 may also serve to send an event to the cluster scheduler 312 or the node agents of the service nodes in order to make the cluster state match the cluster state desired by the cluster administrator or the application service administrator.

The representative functions of the cluster controller 311 may include creation of a namespace and management of the lifecycle thereof, creation/replication of a service instance and management of the lifecycle thereof, autoscaling of a service instance, addition and deletion of a service node, and the like.

The cluster scheduler 312 may serve to search for a suitable service node in which a service instance is to be deployed and to deploy the service instance therein when a request to deploy service instances is made. Here, the cluster scheduler 312 may search for the most suitable service node in consideration of resource requirements of the service instances, service quality requirements, priority, other constraints, and the like based on the resource utilization of each service node (the CPU usage rate or absolute CPU usage, the memory usage rate or absolute memory usage, the IO usage rate or absolute IO usage, and the like), stored in the database 313.

The node agent included in each of the service nodes 320 to 390 corresponding to workers may serve to create/replicate a service instance in the corresponding service node or to change the lifecycle in response to a request from the cluster controller 311 to create/replicate a service instance or to manage the lifecycle. Also, the node agent may also serve to collect the current status of a change in the state of the service instance being executed in the corresponding service node and monitoring metrics, such as CPU usage, memory usage, storage usage, and network usage of the corresponding service node, and to report the same to the cluster controller 311.

Also, the service instance included in each of the service nodes 320 to 390 corresponding to workers is a unit for processing requests from application service users, and may include containers for processing application service requests and containers for managing the inside of the cluster. For example, as illustrated in FIG. 3, the app service A instances deployed in service node 3 340 and service node 6 360 may serve to process app service A. and the app service B instance deployed in service node 5 350 may serve to process app service B.

Here, a load balancer for app service A and a load balancer for app service B are respectively deployed in service node 2 320 and service node 4 330, illustrated in FIG. 3, thereby performing load balancing for processing the respective services.

Accordingly, although devices using app service A (referred to as devices using service A hereinbelow) and devices using app service B (referred to as devices using service B hereinbelow) are temporally and spatially (geographically) distributed, they are able to request processing of the respective services by accessing the respective load balancers for app services provided in service node 2 320 and service node 4 330 via the URL of the corresponding services.

Also, in the container orchestration method according to an embodiment of the present invention, the container orchestration apparatus dynamically deploys service nodes and service instances for processing service requests based on auto-scheduling of the container orchestration cluster based on the environment of multiple geographically distributed clouds at step S120.

Here, in consideration of network proximity of the device using the service, service nodes and service instances may be dynamically deployed such that service instance execution load is balanced.

For example, it may be assumed that a service request for app A is received from the device using service A illustrated in FIG. 3. Here, the load balancer for app service A in service node 2 320 may select the service instance of the service node to receive the corresponding service request in consideration of the network proximity of the device using service A.

Here, the network proximity may correspond to the average network latency, estimated based on the geographical distance between the device using the service and the service node. Here, the average network latency may be checked using any of the following various methods.

For example, the network latency between the device using service A and the node for service A, in which a service A instance is executed, is measured N times, and the average thereof may be used as the average network latency.

In another example, the previously collected average network latency between the IP address band of the device using service A and the IP address band of the node for service A may be used.

In another example, the geolocation of a device corresponding to the IP address of the device using service A is detected based on a geolocation database using IP addresses, and the geographical distance between the device using service A and each of the service nodes in which a service A instance is being executed may be converted to network latency and then used.

As described above, the service nodes and the service instances are dynamically deployed in consideration of network proximity, whereby the problem of delayed service response, which is caused because network proximity is not taken into account in the conventional container orchestration platform, may be solved.

Here, when the service instance that processed a previous service request from the device using service is present, the service request may be processed by the service instance that processed the previous service request.

Referring to FIG. 3, for example, when the service A instance in service node 3 340 processes a service request from the device using service A, subsequent service requests received therefrom may also be delivered to the service A instance in service node 3 340 such that the service request is processed thereby.

However, when there is no service instance that processed a previous service request from the device using the service, the service instance to process the service request may be selected through the following process.

First, at least one candidate service node, including a service instance corresponding to the service request, may be selected from among multiple service nodes constituting the container orchestration cluster.

Here, any one of the at least one candidate service node may be selected as a target service node in consideration of whether the average network latency is equal to or less a preset reference and the balancing of the service instance execution load.

Here, the service request may be processed by a target service instance deployed in the target service node.

For example, when the container orchestration cluster illustrated in FIG. 3 receives a request for app service A from the device using service A, service node 3 340 and service node 6 360, each including a service A instance, may be selected as candidate service nodes. Then, a target service node and a target service instance may be selected in consideration of the network proximity between the device using service A and each of the candidate service nodes and of the execution load of the service A instances being executed in the respective candidate service nodes.

That is, any one service A instance having high network proximity and a low service instance execution load is selected as the target service instance, and the service request from the device using service A may be delivered thereto such that the service request is processed thereby.

Here, the service instance execution load may be determined based on the CPU usage rate or the absolute CPU usage of each of the service instances, the memory usage rate or the absolution memory usage thereof, the IO usage rate or the absolute IO usage thereof, and the like.

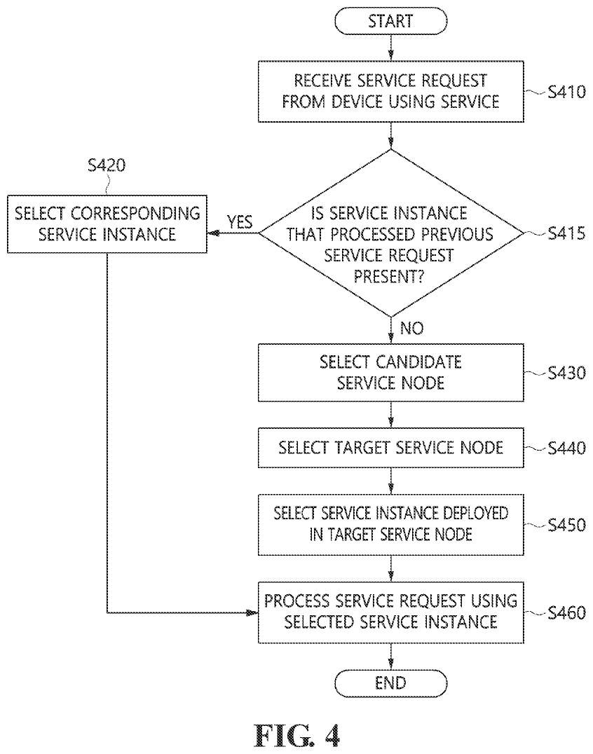

The process described above is summarized in FIG. 4. That is, referring to FIG. 4, when a service request is received from a device using a service at step S410, whether the service instance that processed the previous service request from the device using the service is present may be determined at step S415.

When it is determined at step S415 that a service instance that processed a previous service request from the device using the service is present, the corresponding service instance is selected at step S420, and the service request may be processed by the selected service instance at step S460.

Conversely, when it is determined at step S415 that there is no service instance that processed the previous service request from the device using the service, at least one candidate service node, including a service instance corresponding to the service request, may be selected from among multiple service nodes constituting a container orchestration cluster at step S430.

Subsequently, a target service node is selected from among the at least one candidate service node in consideration of whether the average network latency thereof is equal to or less than a preset reference and of the balancing of the service instance execution load at step S440, and the target service instance deployed in the target service node is selected at step S450, whereby the service request may be processed by the target service instance at step S460.

Also, although not illustrated in FIG. 1, in the container orchestration method according to an embodiment of the present invention, the container orchestration apparatus performs scaling of the container orchestration cluster based on the resource utilization of each service node and resource utilization of each service instance.

Here, a service instance may be added or deleted in consideration of whether the resource utilization measured for service instances of each service type falls within a preset target range of service instance resource utilization.

For example, when the resource utilization measured for service instances of the same service reaches a target value set by the cluster administrator or the app service administrator, the cluster controller 311 illustrated in FIG. 3 automatically requests the cluster scheduler 312 to add or delete a service instance of the corresponding service, whereby the resource utilization may be maintained within the target value range. Here, the resource utilization may include the CPU usage rate or the absolute CPU usage, the memory usage rate or the absolution memory usage, the IO usage rate or the absolute IO usage, and the like.

When the resource utilization of service A instances is measured, if the resource utilization reaches the set target value, a new service A instance is added, or an existing service A instance is deleted, whereby the resource utilization of the service A instances may be maintained within the target value range.

Here, when the service instance resource utilization measured for at least one first service instance providing a first service falls out of the preset target range of service instance resource utilization, a service instance may be added or deleted in consideration of the network proximity to at least one first service node including the at least one first service instance and in consideration of the rate of increase of access by the devices using service and the frequency of access thereby during a preset period.

For example, whether the resource utilization of service A instances falls within a range set based on the target value of the individual service instances or on the target value of the average service instances may be checked.

When the resource utilization of the service A instances is greater than the upper limit of the preset target range of the resource utilization of the service A instances, the rate of increase of access by devices using service A and the frequency of access thereby during a certain recent period may be checked for all of the service A instances.

Subsequently, whether a new service A instance is capable of being added in any of service nodes that include a service A instance having a high rate of increase of access thereto or a high frequency of access thereto may be checked. That is, whether the resource utilization of the service node satisfies the resource requirements of the new service A instance, the service quality requirements thereof, priority, other constraints, and the like may be checked.

Here, if a service node in which a new service A instance is capable of being added is present, a request may be made to the node agent of the corresponding service node to create the new service A instance, and a request may be made to the load balancer for service A to register information about the new service A instance.

However, if there is no service node in which a new service A instance is capable of being added, the new service A instance is not created, and creation thereof may be waited for.

Also, when the resource utilization of service A instances is equal to or less than the lower limit of the preset target range of the resource utilization of the service A instances, the rate of decrease of access by devices using service A and the frequency of access thereby during a certain recent period may be checked for all of the service A instances.

Subsequently, whether an existing service A instance can be deleted from any of services nodes including a service A instance having a high rate of decrease of access thereto or a low frequency of access thereto and whether constraints are satisfied in any of these service nodes may be checked.

Here, if a service node from which the existing service A instance can be deleted is present, a request may be made to the node agent of the corresponding service node to delete the service A instance, and a request to deregister the deleted service A instance may be delivered to the load balancer for service A.

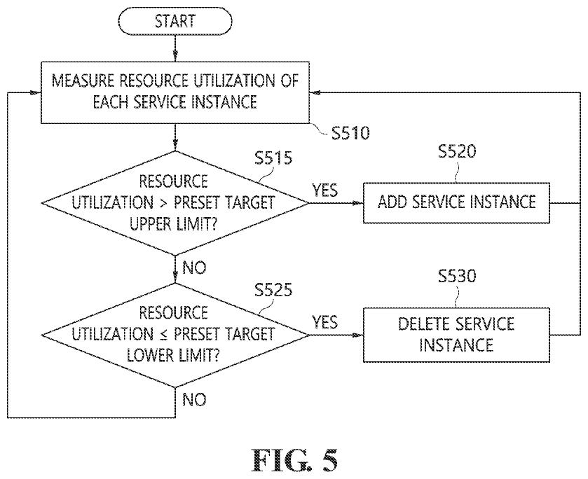

Such a service-instance-scaling process is illustrated in FIG. 5.

Referring to FIG. 5, resource utilization is measured for each service instance at step S510, and whether the measured resource utilization is greater than a preset target upper limit may be determined at step S515.

When it is determined at step S515 that the service instance resource utilization is greater than the preset target upper limit, the process of adding a service instance may be performed at step S520.

Subsequently, the process of service instance scaling, which starts from step S510, is repeatedly performed, whereby continuous management may be performed to balance the service instance execution load.

Also, when it is determined at step S515 that the service instance resource utilization is not greater than the preset target upper limit, whether the service instance resource utilization is equal to or less than a preset target lower limit may be determined at step S525.

When it is determined at step S525 that the service instance resource utilization is equal to or less than the preset target lower limit, the process of deleting a service instance may be performed at step S530.

Subsequently, the process of service instance scaling, which starts from step S510, is repeatedly performed, whereby continuous management may be performed to balance the service instance execution load.

Also, when it is determined at step S525 that the service instance resource utilization is greater than the preset target lower limit, the process of service instance scaling, which starts from step S510, is repeatedly performed, whereby continuous management may be performed to balance the service instance execution load.

Here, a service node may be added or deleted in consideration of whether the service node resource utilization measured for each service node falls within a preset target range of service node resource utilization.

For example, when the resource utilization measured for each service node reaches a target value set by a cluster administrator, the cluster controller 311 illustrated in FIG. 3 automatically requests the cluster scheduler 312 to add or delete a service node, thereby operating such that the resource utilization of the cluster is maintained within the target value range.

If the resource utilization of the cluster reaches the set target value, a new service node is added or an existing service node is deleted, whereby the resource utilization of the cluster may be maintained within the target value range.

Here, when the resource utilization of the cluster, measured based on service node resource utilization, falls out of the preset target range of cluster resource utilization, a service node may be added or deleted in consideration of the service node resource utilization and the network proximity between a cloud region and a group of devices using service, which are grouped in consideration of the rate of increase of access and the frequency of access.

Here, when the resource utilization of the cluster is greater than the upper limit of the preset target range of cluster resource utilization, a target cloud region in which a new service node is to be added may be selected from among a first cloud region, including a service node, the resource utilization of which exceeds the upper limit of the preset target range of the service node resource utilization, among multiple service nodes constituting the container orchestration cluster, and a second cloud region that is selected in consideration of network proximity between the cloud region and the group of devices using service.

For example, when the resource utilization of the cluster is greater than the upper limit of the preset target range of cluster resource utilization, the rate of increase of access by devices using service and the frequency of access thereby during a certain recent period may be checked for a new service instance that is in a standby state without being deployed in a service node by the cluster scheduler.

Subsequently, a service node including a service instance having a high rate of increase of access thereto or a high frequency of access thereto is checked, and the cloud region including the corresponding service node (the first cloud region) may be checked.

Then, a cloud region (the second cloud region) to which a group of devices using service, which includes devices having a high rate of increase of access or a high frequency of access during a certain recent period, have high network proximity may be searched for. Here, the search range may include not only cloud regions constituting the current cluster but also all accessible cloud regions.

Subsequently, the cloud region in which a new service node, that is, a virtual machine, is to be created may be selected from among the checked first cloud region and the found second cloud region.

Subsequently, a new service node may be allocated to the selected cloud region, a node agent may be installed in the new service node, and the service node may be managed by registering the same as the worker of the current cluster.

Also, when the resource utilization of the cluster is equal to or less than the lower limit of the preset target range for the cluster resource utilization, service nodes may be sequentially deleted in the order from the service node having the lowest resource utilization, among all of the service nodes included in the cluster. Here, among the service nodes having low resource utilization, nodes having a small number of service instances being executed therein are deleted first, in which case the service nodes may be repeatedly deleted until the resource utilization of the cluster becomes greater than the target lower limit. Then, the virtual machines of the deleted service node and cloud resources related thereto may be returned to the corresponding cloud region.

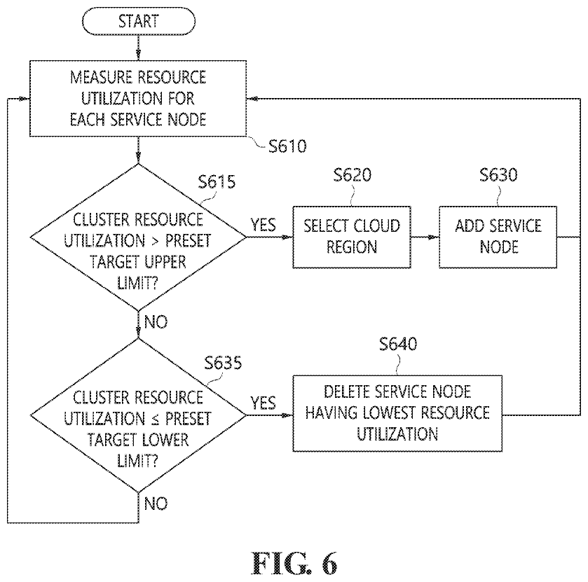

The service-node-scaling process described above is illustrated in FIG. 6.

Referring to FIG. 6, the resource utilization is measured for each service node at step 610, and whether the resource utilization of the cluster measured based thereon is greater than a preset target upper limit may be determined at step S615.

When it is determined at step S615 that the resource utilization of the cluster is greater than the preset target upper limit, a cloud region is selected at step 620, and the process of adding a service node therein may be performed at step S630.

Subsequently, the process of service node scaling, which starts from step S610, is repeatedly performed, whereby continuous management may be performed to balance the service node execution load.

Also, when it is determined at step S615 that the resource utilization of the cluster is not greater than the preset target upper limit, whether the resource utilization of the cluster is equal to or less than a preset target lower limit may be determined at step S635.

When it is determined at step S635 that the resource utilization of the cluster is equal to or less than the preset target lower limit, the process of deleting the service node having the lowest resource utilization first may be performed at step S640.

Subsequently, the process of service node scaling, which starts from step S610, is repeatedly performed, whereby continuous management may be performed to balance the service node execution load.

Also, when it is determined at step S635 that the resource utilization of the cluster is greater than the preset target lower limit, the process of service node scaling, which starts from step S610, is repeatedly performed, whereby continuous management may be performed to balance the service node execution load.

Through the above-described container orchestration method, the virtual machines of multiple geographically distributed clouds and local physical machines are dynamically and appropriately deployed in response to service requests, whereby the service delay time may be minimized and all of the resources of the system may be efficiently used. Accordingly, service management costs may be minimized.

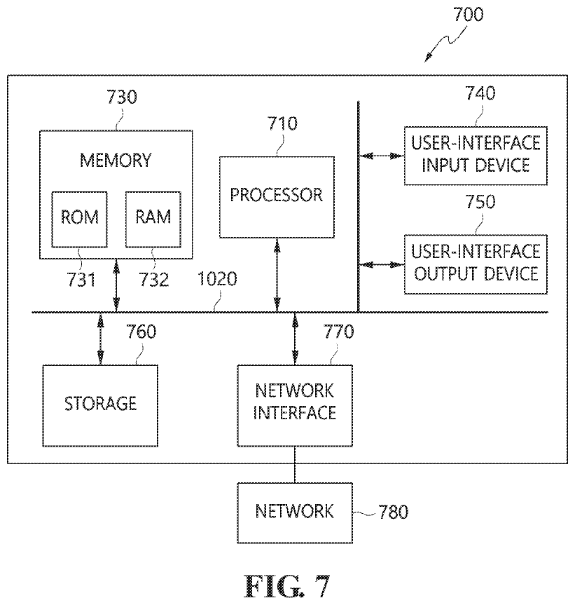

FIG. 7 is a block diagram illustrating a container orchestration apparatus according to an embodiment of the present invention.

Referring to FIG. 7, the container orchestration apparatus 700 according to an embodiment of the present invention may include a processor 710, a bus 720, memory 730, a user-interface input device 740, a user-interface output device 750, storage 760, and a network interface 770.

The processor 710 receives a service request from a device using service.

Here, the service request may be received from multiple devices that use service and are possessed by multiple users that are temporally and/or geographically distributed.

Also, the processor 710 dynamically deploys service nodes and service instances for processing the service request based on auto-scheduling for a container orchestration cluster based on an environment of multiple geographically distributed clouds.

Here, the service nodes and the service instances may be dynamically deployed such that the service instance execution load is balanced in consideration of the network proximity of the devices using the service.

Here, the network proximity may be the average network latency estimated based on the geographical distance between the device using the service and the service node.

Here, when a service instance that processed a previous service request from the device using the service is present, the service request may be processed by the service instance that processed the previous service request.

Here, when there is no service instance that processed a previous service request from the device using the service, at least one candidate service node including a service instance corresponding to the service request may be selected from among multiple service nodes constituting the container orchestration cluster.

Here, any one of the at least one candidate service node is selected as a target service node in consideration of whether the average network latency is equal to or less than a preset reference and of the balancing of the service instance execution load.

Here, the service request may be processed by the target service instance that is deployed in the target service node.

Also, the processor 710 performs scaling of the container orchestration cluster based on the resource utilization of each service node and the resource utilization of each service instance.

Here, a service instance may be added or deleted in consideration of whether the resource utilization measured for service instances of each service type falls within a preset target range of service instance resource utilization.

Here, when the resource utilization measured for at least one first service instance providing a first service falls out of the preset target range of service instance resource utilization, a service instance may be added or deleted in consideration of network proximity to at least one first service node including the at least one first service instance and of the rate of increase of access thereto by devices using service and the frequency of access thereto by the devices using service during a preset period.

Here, a service node may be added or deleted in consideration of whether the resource utilization measured for each service node falls within a preset target range of service node resource utilization.

Here, when the resource utilization of the cluster, measured based on the resource utilization of the service nodes, falls out of a preset target range of cluster resource utilization, a service node may be added or deleted in consideration of the resource utilization of the service nodes and the network proximity between a cloud region and a group of devices using service, which are grouped in consideration of the rate of increase of access and the frequency of access.

Here, when the resource utilization of the cluster is greater than the upper limit of the preset target range of the cluster resource utilization, the target cloud region in which a new service node is to be added may be selected from among a first cloud region, including a service node having resource utilization exceeding the upper limit of the preset target range of the service node resource utilization, among the multiple service nodes constituting the container orchestration cluster, and a second cloud region, which is selected in consideration of network proximity between the cloud region and the group of devices using the service.

The memory 730 stores information about the state of the container orchestration cluster.

Also, the memory 730 stores various kinds of information generated in the above-described container orchestration apparatus in an environment of multiple geographically distributed clouds according to an embodiment of the present invention.

According to an embodiment, the memory 730 may be separate from the container orchestration apparatus, and may support the function for container orchestration. Here, the memory 730 may operate as separate mass storage, and may include a control function for performing operations.

Using the above-described container orchestration apparatus, virtual machines of multiple geographically distributed clouds and local physical machines are dynamically and appropriately deployed in response to service requests, whereby the service delay time may be minimized and all system resources may be efficiently used. Accordingly, service management costs may be minimized.

Also, referring to FIG. 7, an embodiment of the present invention may be implemented in a computer system including a computer-readable recording medium. For example, as illustrated in FIG. 7, the computer system may include one or more processors 710, memory 730, a user-interface input device 740, a user-interface output device 750, and storage 760, which communicate with each other via a bus 720. Also, the computer system 700 may further include a network interface 770 connected to a network 780. The processor 710 may be a central processing unit or a semiconductor device for executing processing instructions stored in the memory 730 or the storage 760. The memory 730 and the storage 760 may be any of various types of volatile or nonvolatile storage media. For example, the memory may include ROM 731 or RAM 732.

Accordingly, an embodiment of the present invention may be implemented as a non-transitory computer-readable storage medium in which methods implemented using a computer or instructions executable in a computer are recorded. When the computer-readable instructions are executed by a processor, the computer-readable instructions may perform a method according to at least one aspect of the present invention.

According to the present invention, container orchestration technology for multiple geographically distributed clouds through which the service response time taken to provide service in response to service requests from multiple users can be minimized may be provided.

Also, the present invention may enable effective scheduling and scaling to be performed for multiple geographically distributed clouds in consideration of network proximity and system load.

Also, the present invention may minimize a service delay time and minimize service management costs by efficiently using all system resources when a container orchestration platform based on multiple geographically distributed clouds is operated.

As described above, the container orchestration apparatus in an environment of multiple geographically distributed clouds and the method using the same according to the present invention are not limitedly applied to the configurations and operations of the above-described embodiments, but all or some of the embodiments may be selectively combined and configured, so that the embodiments may be modified in various ways.

What is claimed is:

1. A method for container orchestration, comprising:
receiving, by a container orchestration apparatus, a service request from a device using a service; and
dynamically deploying, by the container orchestration apparatus, a service node and a service instance for processing the service request based on auto-scheduling of a container orchestration cluster based on an environment of multiple geographically distributed clouds.

2. The method of claim 1, wherein:
dynamically deploying the service node and the service instance is configured to dynamically deploy the service node and the service instance such that a service instance execution load is balanced in consideration of network proximity of the device using the service.

3. The method of claim 2, wherein:
the network proximity corresponds to an average network latency, estimated based on a geographical distance between the device using the service and the service node.

4. The method of claim 3, wherein dynamically deploying the service node and the service instance comprises:
selecting at least one candidate service node, including a service instance corresponding to the service request, from among multiple service nodes constituting the container orchestration cluster;
selecting any one of the at least one candidate service node as a target service node in consideration of whether the average network latency is equal to or less than a preset reference and in consideration of balancing of the service instance execution load; and
processing the service request using a target service instance deployed in the target service node.

5. The method of claim 2, wherein dynamically deploying the service node and the service instance comprises:
when a service instance that processed a previous service request made by the device using the service is present, processing the service request using the service instance that processed the previous service request.

6. The method of claim 1, further comprising:
performing, by the container orchestration apparatus, scaling of the container orchestration cluster based on resource utilization of each service node and resource utilization of each service instance.

7. The method of claim 6, wherein performing the scaling comprises:
performing service instance scaling through which a service instance is added or deleted in consideration of whether the resource utilization measured for each service instance of each service type falls within a preset target range of service instance resource utilization; and
performing service node scaling through which a service node is added or deleted in consideration of whether the resource utilization measured for each service node falls within a preset target range of service node resource utilization.

8. The method of claim 7, wherein:
performing the service instance scaling is configured such that, when the resource utilization measured for at least one first service instance providing a first service falls out of the preset target range of the service instance resource utilization, the service instance is added or deleted in consideration of network proximity to at least one first service node including the at least one first service instance and in consideration of a rate of increase of access thereto by devices using the at least one first service and a frequency of access thereto during a preset period.

9. The method of claim 8, wherein:
performing the service node scaling is configured such that, when cluster resource utilization, measured based on the resource utilization of each service node, falls out of a preset target range of cluster resource utilization, the service node is added or deleted in consideration of the resource utilization of each service node and network proximity between a cloud region and a group of devices using service, which are grouped in consideration of the rate of increase of access and the frequency of access.

10. The method of claim 9, wherein performing the service node scaling comprises:
when the cluster resource utilization is greater than an upper limit of the preset target range of the cluster resource utilization, selecting a target cloud region, in which a new service node is to be added, from among a first cloud region, including a service node having resource utilization exceeding an upper limit of the preset target range of the service node resource utilization, among multiple service nodes constituting the container orchestration cluster, and a second cloud region, selected in consideration of network proximity between the cloud region and the group of devices using service.

11. The method of claim 1, wherein the service node is a virtual machine based on a cloud or a physical machine.

12. An apparatus for container orchestration, comprising:
a processor for receiving a service request from a device using a service and dynamically deploying a service node and a service instance for processing the service request based on auto-scheduling of a container orchestration cluster based on an environment of multiple geographically distributed clouds; and
memory for storing information about a state of the container orchestration cluster.

13. The apparatus of claim 12, wherein:
the processor dynamically deploys the service node and the service instance such that a service instance execution load is balanced in consideration of network proximity of the device using the service.

14. The apparatus of claim 13, wherein:
the network proximity corresponds to an average network latency, estimated based on a geographical distance between the device using the service and the service node.

15. The apparatus of claim 14, wherein:
the processor selects at least one candidate service node, including a service instance corresponding to the service request, from among multiple service nodes constituting the container orchestration cluster, selects any one of the at least one candidate service node as a target service node in consideration of whether the average network latency is equal to or less than a preset reference and in consideration of balancing of the service instance execution load, and processes the service request using a target service instance deployed in the target service node.

16. The apparatus of claim 13, wherein:
when a service instance that processed a previous service request made by the device using the service is present, the processor processes the service request using the service instance that processed the previous service request.

17. The apparatus of claim 12, wherein:
the processor performs scaling of the container orchestration cluster based on resource utilization of each service node and resource utilization of each service instance.

18. The apparatus of claim 17, wherein:
the processor performs service instance scaling through which a service instance is added or deleted in consideration of whether the resource utilization measured for each service instance of each service type falls within a preset target range of service instance resource utilization and performs service node scaling through which a service node is added or deleted in consideration of whether the resource utilization measured for each service node falls within a preset target range of service node resource utilization.

19. The apparatus of claim 18, wherein:
when the resource utilization measured for at least one first service instance providing a first service falls out of the preset target range of the service instance resource utilization, the processor adds or deletes the service instance in consideration of network proximity to at least one first service node including the at least one first service instance and in consideration of a rate of increase of access thereto by devices using the at least one first service and a frequency of access thereto during a preset period.

20. The apparatus of claim 19, wherein:
when cluster resource utilization, measured based on the resource utilization of each service node, falls out of a preset target range of cluster resource utilization, the processor adds or deletes the service node in consideration of the resource utilization of each service node and network proximity between a cloud region and a group of devices using service, which are grouped in consideration of the rate of increase of access and the frequency of access.
